(19) United States
(12) Patent Application Publication
(10) Pub. No.: US 2020/0009950 A1
(43) Pub. Date: Jan. 9, 2020

(54) SUNROOF APPARATUS

(71) Applicant: AISIN WUXI BODY PARTS CO., LTD., Jiangsu (CN)

(72) Inventor: Kazuki SAWADA, Jiangsu (CN)

(73) Assignee: AISIN WUXI BODY PARTS CO., LTD., Jiangsu (CN)

(21) Appl. No.: 16/263,320

(22) Filed: Jan. 31, 2019

(30) Foreign Application Priority Data
Jul. 9, 2018 (CN) 201821086136.9

(51) Int. Cl. B60J 7/043; B60J 10/82

(52) U.S. Cl. CPC B60J 7/043; E05Y 2900/542; B60J 10/82

(57) ABSTRACT

A sunroof apparatus includes: a movable panel which is configured to open and close a roof opening; and a panel reinforcement portion, one end of which being close to a center of the roof opening is connected with the movable panel, and the other end of which being away from the center of the roof opening is located on a side being away from the center of the roof opening with respect to an edge of the roof opening, the panel reinforcement portion is provided with a recess which is located below the edge of the roof opening, and is provided with a notch or a hole. According to the sunroof apparatus, the invading water can be stored by a simple structure, and water and dust can be effectively prevented from invading a sliding range of a functional member to thereby effectively maintain a sliding performance of the functional member.

### TECHNICAL FIELD

The invention relates to a sunroof apparatus, and more particularly, to a sunroof apparatus for a vehicle.

### BACKGROUND

In the prior art, there is a known sunroof apparatus in which a pair of guide rails is arranged at two opposite edges in a vehicle widthwise direction of a substantially quadrangular opening formed at a roof of a vehicle, and a movable panel of the sunroof apparatus is supported to open and close the opening through movement of a functional member along the pair of guide rails. For example, the functional member is a shoe for supporting the movable panel so as to move along a front-rear direction, a bracket for supporting the movable panel so as to move obliquely, etc.

For example, the patent document 1 discloses a sunroof apparatus. Specifically, referring to FIG. 7 of the present application that schematically illustrates a part of FIG. 3 of the patent document 1, in the sunroof apparatus, a movable panel 100 is supported by a panel reinforcement portion 101, and a member 102 for storing invading water is additionally arranged below the panel reinforcement portion 101.

### PRIOR ART DOCUMENT

Patent document 1: Chinese utility model patent CN203666352U

However, the sunroof apparatus of the patent document 1 has a problem that the member for storing the invading water needs to be additionally provided, so that the number of the members are increased, and the structure is complicated.

In addition, there is a problem in the prior art that external water, dust or the like can easily invade an arrangement space of the functional member through the gap between the movable panel and the roof opening, thereby easily causing deterioration of a sliding performance of the functional member.

### SUMMARY

The object of the invention is to provide a sunroof apparatus capable of effectively storing invading water by a simple structure and effectively preventing water and dust from invading an arrangement space of a functional member to effectively maintain a sliding performance of the functional member.

A technical solution of the invention is as follows: a sunroof apparatus includes: a movable panel which is located below a roof when the sunroof apparatus is in a fully open state and is configured to open and close a roof opening; and a panel reinforcement portion, one end of which being close to a center of the roof opening is connected with the movable panel, and the other end of which being away from the center of the roof opening is located on a side being away from the center of the roof opening with respect to an edge of the roof opening in a fully closed state of the sunroof apparatus, the panel reinforcement portion is provided with a recess which is located below the edge of the roof opening in the fully closed state of the sunroof apparatus. According to the technical solution, as the panel reinforcement portion below the edge of the roof opening is provided with the recess, the inflow water can be accommodated in the recess on a panel side.

In the above technical solution, preferably, the panel reinforcement portion is a framework member which is capable of keeping rigidity of the movable panel and is fixed to the movable panel by bonding or injection molding.

Therefore, the movable panel can be reliably supported.

In the above technical solution, preferably, in the fully closed state of the sunroof apparatus, the recess is only arranged below two opposite side edges in a vehicle widthwise direction of the roof opening, and below a rear edge of opposite edges in a vehicle front-rear direction of the roof opening which is located at the rear of the vehicle.

In this way, as the panel reinforcement portion at a front edge of the movable panel is not provided with the recess, the front of the vehicle will not be hooked by other members at the roof opening due to the existence of the recess, so that the sunroof apparatus can be smoothly opened and closed.

In the above technical solution, preferably, a waterproof elastomer is arranged between the panel reinforcement portion and the roof on one side of the recess away from the center of the roof opening.

In this way, water, dust or the like can be prevented from invading the arrangement space of a functional member.

In the above technical solution, preferably, a sealing member is arranged at an edge of the movable panel, and the waterproof elastomer is integrally formed with the sealing member.

In this way, as the waterproof elastomer is integrally formed with the sealing member, the number of the members can be further reduced, and the structure is simplified.

In the above technical solution, preferably, a notch or a hole is provided at a position in the recess opposite to the edge of the roof opening.

Therefore, water can be discharged at any position in a guide rail member, and thus no additional drain member needs to be arranged at the rear of the roof opening as in the prior art, and an existing structure, such as a structure for storing a deflector arm and the like, can be used as a drain portion, so that the weight of the sunroof apparatus can be reduced, and the cost is lowered.

In the above technical solution, preferably, the sunroof apparatus is further provided with: a pair of guide rail members which is arranged along the vehicle front-rear direction, on two opposite side edges in the vehicle widthwise direction of the roof opening; and a functional member which is configured to move along the pair of guide rail members and support the movable panel to open and close the roof opening, and the other end of the panel reinforcement portion away from the center of the roof opening is connected with a functional member support portion supported on the functional member.

### BRIEF DESCRIPTION OF THE DRAWINGS

FIG. 1 is a schematic perspective view showing a sunroof apparatus arranged on a roof.

FIG. 2 is a rear side sectional view showing the sunroof apparatus of the present embodiment.

FIG. 3 is a rear side sectional view showing the sunroof apparatus of the present embodiment.

FIG. 4 is a left side sectional view showing the sunroof apparatus of the present embodiment.

FIG. 5 is a right side sectional view showing the sunroof apparatus of the present embodiment.

FIG. 6 is a sectional view schematically showing the front and the rear of the sunroof apparatus of the present embodiment.

FIG. 7 is a view of the prior art.

### REFERENCE SIGNS

1 sunroof apparatus
10 guide rail member
11 functional member accommodating portion
15 drain portion
16 partition wall
17 deflector arm
2 roof opening
20 roof
21 left edge
22 right edge
23 front edge
24 rear edge
3 movable panel
4 functional member
5 functional member support portion
7 sealing member
8 panel reinforcement portion
81 one end
82 the other end
83 recess
84 hole
9 waterproof elastomer

### DETAILED DESCRIPTION OF THE EMBODIMENTS

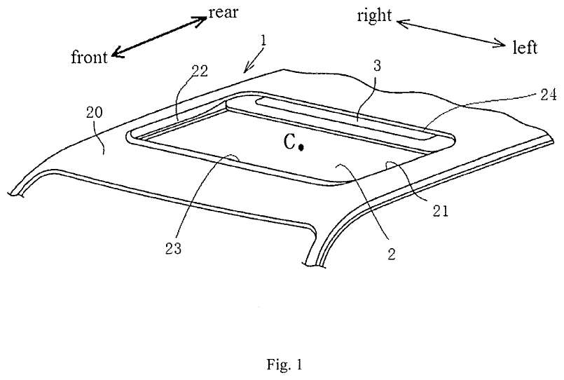

Hereinafter, the sunroof apparatus of the present embodiment will be specifically described with reference to FIGS. 1 to 6.

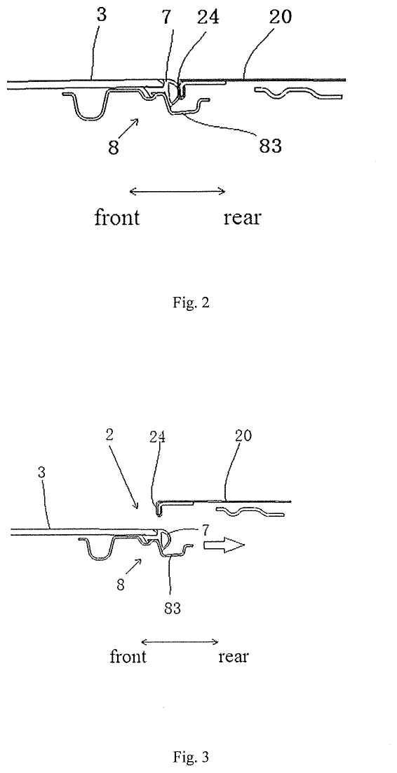

In FIG. 1, the “front” direction indicates a direction toward the front of a vehicle, the “rear” direction indicates a direction toward the rear of the vehicle, the “left” direction indicates a leftward direction when orienting toward the front of the vehicle, the “right” direction indicates a rightward direction orienting toward the front of the vehicle, the “front-rear direction” corresponds to a “vehicle front-rear direction”, and the “left-right direction” corresponds to a “vehicle widthwise direction”. The “front-rear direction” in FIGS. 2, 3 and 6 also corresponds to the “vehicle front-rear direction”.

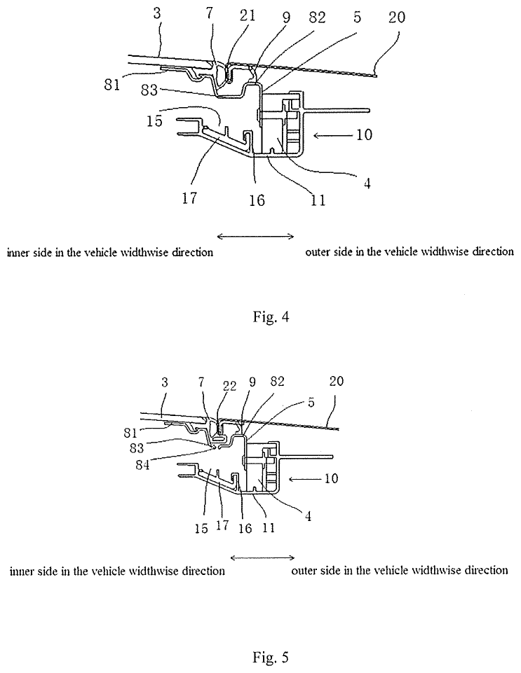

In FIGS. 4 and 5, the exterior-interior direction of a paper surface is the vehicle front-rear direction, the left-right direction of the paper surface is the vehicle widthwise direction, and the upper-lower direction of the paper surface is the upper-lower direction of the vehicle. FIG. 4 shows a sectional view at a guide rail member on the left side of the vehicle, and FIG. 5 shows a sectional view at a guide rail member on the right side of the vehicle.

As shown in FIGS. 1 to 6, the sunroof apparatus 1 of the present embodiment includes a pair of guide rail members 10, 10; a movable panel 3; a functional member 4; a panel reinforcement portion 8; a deflector; and a waterproof elastomer 9.

The pair of guide rail members 10, 10 is arranged along the vehicle front-rear direction, on two opposite side edges in the vehicle widthwise direction of a roof opening 2 formed in a vehicle roof 20.

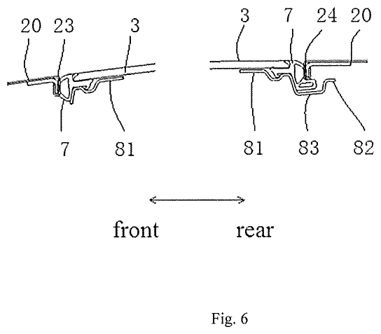

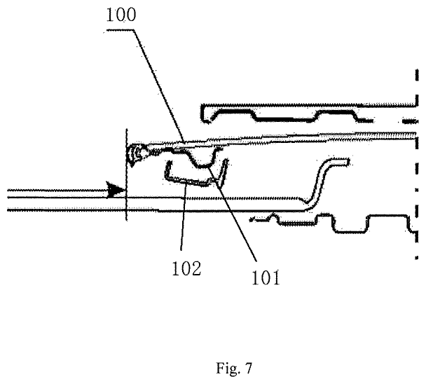

The movable panel 3 is a transparent panel for opening and closing the roof opening 2. As shown in FIGS. 2 and 3, the sunroof apparatus 1 of the present embodiment is a so-called internal sliding sunroof apparatus in which the movable panel 3 is located below the roof 20 whenin the sunroof apparatus is in a fully open state, that is, when the roof opening 2 is completely opened through the movement of the movable panel 3. Specifically, when the roof opening 2 is opened, after the movable panel 3 is firstly descended, as shown by a hollow arrow in FIG. 3, the movable panel 3 slides backward to the lower side of the roof 20. A sealing member 7 (weather strip) is arranged on an edge of the movable panel 3, for abutting against the edge of the roof opening 2 to form a seal for preventing external water, dust or the like from invading through a gap between the movable panel 3 and the roof opening 2, in a fully closed state. As shown in FIGS. 5 and 6, a part of the sealing member 7 can be an elastic structure provided with a main body portion which is press-contacted a bent portion of a vehicle top plate in the vehicle widthwise direction and a press-contacted portion which is connected with the main body portion and is press-contacted a lower end of the bent portion of the vehicle top plate in the vehicle upper-lower direction in the fully closed state of the sunroof apparatus. Therefore, the external water, dust and the like can be further prevented from invading through the gap between the movable panel 3 and the roof opening 2.

The functional member 4 is configured to move along the pair of guide rail members 10, 10 and support the movable panel 3 to open and close the roof opening 2. For example, the functional member 4 is a pair of shoes sliding along the pair of guide rail members 10, 10, and the movable panel 3 can be driven to move in the vehicle front-rear direction by the pair of shoes. The functional member 4 can also include a pair of brackets (not shown) for supporting the movable panel 3. The movable panel 3 can be moved obliquely in the vehicle upper-lower direction by the brackets, that is, the movable panel 3 can be tilted upward or tilted downward through the rotation of the brackets around a fixed shaft.

The panel reinforcement portion 8 is arranged between the functional member 4 and the movable panel 3, is a framework member capable of keeping the rigidity of the movable panel 3 and is fixed to the movable panel 3 through bonding or injection molding. For example, the framework member is made of a metal with relatively high rigidity. The panel reinforcement portion 8 is arranged at front, rear, left and right end edges of the movable panel 3, which can be four independent members or can also be an integrally-formed member.

As shown in FIGS. 4 and 5, one end 81 of the panel reinforcement portion 8 close to the center C (referring to FIG. 1) of the roof opening 2 is connected with the movable panel 3, and the other end 82 of the panel reinforcement portion 8 away from the center C of the roof opening 2 is located on a side away from the center C of the roof opening 2 with respect to edges (a left edge 21 and a right edge 22) of the roof opening 2 in the fully closed state of the sunroof apparatus 1. The other end 82 of the panel reinforcement portion 8 away from the center C of the roof opening 2 is connected with a functional member support portion 5 supported on the functional member 4. In another embodiment, the panel reinforcement portion 8 and the functional member support portion 5 can be integrally formed. By means of the above connected structure, the movable panel 3 can be stably supported when the functional member 4 moves along the guide rail member 10.

The panel reinforcement portion 8 is provided with a recess 83 which is located below the edge of the roof opening 2, and a notch or a hole 84 is provided at a position in the recess 83 opposite to the edge of the roof opening 2. By arranging a drain portion 15 of the guide rail member 10 below the recess 83, water can be easily discharged to the outside through the provided notch or hole 84. Specifically, in such a structure, on the left side or the right side of the vehicle, in the vehicle upper-lower direction, the recess 83 is formed directly below the edge of the roof opening 2, and the drain portion 15 is formed directly below the recess 83. Further, regarding to the panel reinforcement portion 8 on the rear side of the vehicle, in the fully closed state of the sunroof apparatus 1, in the vehicle upper-lower direction, the recess 83 of the panel reinforcement portion 8 is formed directly below the edge of the roof opening 2.

As shown in FIGS. 3 and 6, the movable panel 3 slides toward the rear of the vehicle to open the roof opening 2, and the recess 83 is only arranged below two opposite side edges (the left edge 21 and the right edge 22) in the vehicle widthwise direction of the roof opening 2, and below a rear edge 24, located at the rear of the vehicle, of two opposite edges in the vehicle front-rear direction of the roof opening 2.

That is, the recess 83 is not arranged in the panel reinforcement portion 8 on the front end edge of the movable panel 3, this is because when the movable panel 3 slides backward to open the roof opening 2, the front end edge of the movable panel 3 generates an upward tilting action of obliquely moving upward, and if the recess is arranged in the panel reinforcement portion on the front end edge, the recess may be hooked by a member (or members) in the roof, resulting in a poor situation that the movable panel 3 cannot be smoothly opened.

As shown in FIGS. 4 and 5, a deflector arm 17 of a deflector is arranged in the drain portion 15 of the guide rail member 10. Specifically, each guide rail member 10 is provided with a functional member accommodating portion 11 and the drain portion 15. The drain portion 15 is arranged on the inner side in the vehicle widthwise direction of the functional member accommodating portion 11 with the partition wall 16 therebetween and is formed into a groove shape.

The deflector is used for rectifying air entering from the front of the vehicle in a open state of the sunroof apparatus, and is provided with: a deflector main body (not shown) extending along the vehicle widthwise direction; and the deflector arm 17 extending along the vehicle front-rear direction. Specifically, the deflector main body is arranged in the front of the vehicle with respect to the deflector arm 17 and can rotate with a rear end of the deflector arm 17 as a fulcrum. More specifically, in the front of the vehicle, the deflector main body of the deflector is arranged between the drain portions 15 of the pair of guide rail members 10, 10, and a pair of deflector arms 17, 17 is respectively arranged on the drain portions 15 of the guide rail members 10, 10 on both sides. In this way, the water brought by the deflector can easily flow into the drain portions 15 and be discharged. By accommodating the water falling from the hole 84 of the recess 83 or the like through the deflector arm 17 arranged on the drain portion, the water can be prevented from splashing into a vehicle chamber.

As shown in FIGS. 4 and 5, the waterproof elastomer 9 is arranged between the panel reinforcement portion 8 and the roof 20 and is arranged on one side of the recess 83 away from the center C of the roof opening 2. The waterproof elastomer 9 can be a known elastic seal such as a O-shaped ring The waterproof elastomer 9 can be fixed to a bottom surface of the roof 20 and can also be fixed to the other end 82 of the panel reinforcement portion 8. In the present embodiment, the waterproof elastomer 9 and the sealing member 7 are different members, but the waterproof elastomer 9 may also be integrally formed with the sealing member 7. For example, the waterproof elastomer 9 may be directly connected to the main body portion or the press-contacted portion of the sealing member 7. By providing the waterproof elastomer 9 between the panel reinforcement portion 8 and the roof 20, even if a part of water and dust invade through the gap between the sealing member 7 and the roof opening 2, the water and dust can be blocked at the outside of the functional member accommodating portion 11, so that the sliding performance of the functional member 4 can be better maintained.

The preferred embodiment of the invention have been described above, but the invention is not limited thereto, and various variations can be made without departing from the scope of the spirit of the invention.

For example, in the above embodiment, the material of the panel reinforcement portion is a metal, but the invention is not limited thereto, and any material having higher rigidity and capable of reliably supporting the movable panel may be used.

For example, in the above embodiment, the structure in which the drain portion is formed at a portion accommodating the deflector arm has been described. However, the structure of the drain portion is not limited thereto, and the drain portion may also be arranged as an additional member on a rear portion of the roof opening.

For example, in the above embodiment, an example in which the recess is provided with the hole or the notch has been described. However, the invention is not limited thereto, and the hole or notch may also not be formed in the recess.

In the above embodiment, the structure in which the movable panel slides toward the rear of the vehicle to open the roof opening has been described. However, the invention is not limited thereto, and a structure in which the movable panel slides toward the front of the vehicle to open the roof opening may be used.

In the above embodiment, the structure of the sunroof apparatus only having the movable panel has been described. However, the invention is not limited thereto, and a structure in which a transparent fixed panel is arranged at the roof, and the moving panel is located below the fixed panel when the sunroof apparatus is in the fully open state may be used.

The present embodiment has been described above with reference to a specific example. However, the invention is not limited to the specific example. A design obtained by those skilled in the art by applying a suitable design change to the specific example is also included within the scope of the invention as long as it has the features of the invention.

1. A sunroof apparatus, comprising:
a movable panel which is located below a roof when the sunroof apparatus is in a fully open state and is configured to open and close a roof opening; and
a panel reinforcement portion, one end of which being close to a center of the roof opening is connected with the movable panel, and the other end of which being away from the center of the roof opening is located on a side being away from the center of the roof opening with respect to an edge of the roof opening in a fully closed state of the sunroof apparatus,
the panel reinforcement portion is provided with a recess which is located below the edge of the roof opening in the fully closed state of the sunroof apparatus.

2. The sunroof apparatus according to claim 1, wherein
the panel reinforcement portion is a framework member that is capable of keeping the rigidity of the movable panel, and is fixed to the movable panel by bonding or injection molding.

3. The sunroof apparatus according to claim 1, wherein
in the fully closed state of the sunroof apparatus, the recess is only arranged below two opposite side edges in a vehicle widthwise direction of the roof opening, and below a rear edge of opposite edges in a vehicle front-rear direction of the roof opening which is located at the rear of the vehicle.

4. The sunroof apparatus according to claim 2, wherein
a waterproof elastomer is arranged between the panel reinforcement portion and the roof on one side of the recess which is away from the center of the roof opening.

5. The sunroof apparatus according to claim 4, wherein
a sealing member is arranged at an edge of the movable panel, and the waterproof elastomer is integrally formed with the sealing member.

6. The sunroof apparatus according to claim 1, wherein
a notch or a hole is provided at a position in the recess opposite to the edge of the roof opening.

7. The sunroof apparatus according to claim 1, further comprising:
a pair of guide rail members which is arranged along the vehicle front-rear direction, on two opposite side edges in the vehicle widthwise direction of the roof opening; and
a functional member which is configured to move along the pair of guide rail members and support the movable panel to open and close the roof opening,
the other end of the panel reinforcement portion which is away from the center of the roof opening is connected with a functional member support portion supported on the functional member.
